(19) United States
(12) Patent Application Publication
(10) Pub. No.: US 2012/0060509 A1
(43) Pub. Date: Mar. 15, 2012

(54) Inner Bleed Structure of 2-Shaft Gas Turbine and a Method to Determine the Stagger Angle of Last Stage Stator of Compressor for 2-Shaft Gas Turbine

(75) Inventors: Chihiro MYOREN, Tokai (JP); Ryou Akiyama, Hitachinaka (JP); Shinya Marushima, Hitachinaka (JP); Yasuo Takahashi, Mito (JP); Shinichi Higuchi, Hitachinaka (JP)

(73) Assignee: Hitachi, Ltd., Tokyo (JP)

(21) Appl. No.: 13/198,751

(22) Filed: Aug. 5, 2011

(30) Foreign Application Priority Data
Sep. 14, 2010 (JP) 2010-205246

(51) Int. Cl. F02C 6/04; G01M 15/14

(52) U.S. Cl. 60/785; 73/112.05

(57) ABSTRACT

An inner bleed structure of the 2-shaft gas turbine includes a slit for leading part of compressed air to a cavity is formed between a wall surface of a rotor wheel of the compressor equipped with a last stage rotor of the compressor which is connected to a first rotating shaft and end of an inner casing, and a bleed hole for leading part of compressed air after flowing down the last stage of the compressor to a cavity formed in the inner side of the inner casing at the downstream side of the last stage of the compressor.

### CLAIM OF PRIORITY

The present application claims priority from Japanese patent application JP 2010-205246 filed on Sep. 14, 2010, the content of which is hereby incorporated by reference into this application.

### BACKGROUND OF THE INVENTION

1. Field of the Invention

The present invention relates to an inner bleed structure of a 2-shaft gas turbine constituted of a high pressure turbine for driving a compressor and a low pressure turbine for driving a load each of which has a separate shaft, and particularly to an inner bleed structure of a 2-shaft gas turbine that feeds cooling air from the compressor to the turbines and a method to determine a stagger angle of the last stage stator of the compressor for the 2-shaft gas turbine.

2. Description of Related Art

In association with energy demand increase of recent years, there is a growing need for gas turbines for driving a machine that are suitable for production of liquid natural gas (LNG).

In LNG plants, natural gas is made to be high pressure by a compressor to liquefy, and the 2-shaft gas turbines are used to drive a compressor for liquefying LNG in many cases.

The 2-shaft gas turbines having two rotating shafts such as described in Japanese Patent Laid-open No. 2005-337082 are characterized in that the turbine part is separated into the low pressure turbine that drives the load such as the LNG compressor and a generator and the high-pressure turbine connected to a compressor, and each turbine is connected to a separate rotating shaft. The 2-shaft gas turbines are used for power generation with being connected to a generator in some cases in addition to machine driving use described above.

For gas turbines for power generation, 1-shaft gas turbines are mainly used that are simple in structure, easy to operate, and rotate compressors and turbines by the common rotating shafts, but there is a problem where a reduction gear is required to maintain the revolution speed of a generator when miniaturization of equipment is required.

In contrast, in the 2-shaft gas turbines, since the revolution speed of the high pressure turbine and the low pressure turbine can be selected arbitrarily, the reduction gear is not necessary, and the turbine can be made compact and highly-efficient. However, the 2-shaft gas turbines have a problem where the inner bleed structure that feeds cooling air from the compressor to the turbine gets complex compared to the 1-shaft gas turbines.

### PRIOR ART DOCUMENTS

### Patent Document

Patent document 1: Japanese Patent Laid-open No. 2005-337082

### SUMMARY OF THE INVENTION

In the inner bleed structure of the 2-shaft gas turbine disclosed in Japanese Patent Laid-open No. 2005-337082, since a seal exists on an inner side of an inner casing that is located on the way of the high pressure air path from a slit formed between the last stage rotor and stator of the compressor to an inducer formed in a rotating shaft, the flow rate of high pressure air flowing from the slit to the inducer formed in the rotating shaft via an inner bleed cavity formed in the inner side of the inner casing becomes very small.

In the structure of the slit formed between the last stage rotor and stator of the compressor, a wall surface of a rotor wheel of the compressor, the wall surface being an upstream side wall surface of the slit, rotates, so if the air flow rate passing through the slit is very small, the flow cannot overcome centrifugal force that is given to the air by the rotating wall of the rotor wheel of the compressor via frictional force, and reverse flow is generated at the last stage rotor side of the compressor of the slit.

When reverse flow is generated at the slit, since turbulence occurs in the main flow of the last stage stator of the compressor, the loss of the last stage stator of the compressor increases, and there is a possibility that stress acting on the last stage stator of the compressor increases due to occurrence of instability phenomena caused by separation of flow etc.

An object of the present invention is to provide an inner bleed structure of the 2-shaft gas turbine that improves reliability of the last stage stator of the compressor by restraining reverse flow that is generated at a slit formed between the last stage rotor and the stator of the compressor and a method to determine the stagger angle of the last stage stator of the compressor for the 2-shaft gas turbine.

An inner bleed structure of the 2-shaft gas turbine of the present invention comprising: a compressor that compresses and discharges air; a combustor that combusts compressed air compressed by the compressor and fuel to generate combustion gas; a high pressure turbine connected to the compressor with a first rotating shaft and driven by the combustion gas generated by the combustor; a low pressure turbine driven by the combustion gas exhausted from the high pressure turbine and connected with a second rotating shaft; an inner casing located between the compressor and the high pressure turbine and installed at the outer side of the first rotating shaft; and a cavity formed between the inner side of the inner casing and the outer side of the first rotating shaft, characterized in that a slit for leading part of the compressed air to the cavity is formed between a wall surface of a rotor wheel of the compressor equipped with the last stage rotor of the compressor which is connected to the first rotating shaft and end of the inner casing, and a bleed hole for leading part of the compressed air after flowing down the last stage of the compressor to the cavity is formed in the inner casing at a position on a downstream side of the last stage of the compressor.

An inner bleed structure of the 2-shaft gas turbine of the present invention comprising: a compressor that compresses and discharges air; a combustor that combusts compressed air compressed by the compressor and fuel to generate combustion gas; a high pressure turbine connected to the compressor with a first rotating shaft and driven by the combustion gas generated by the combustor; a low pressure turbine driven by the combustion gas exhausted from the high pressure turbine and connected with a second rotating shaft; an inner casing located between the compressor and the high pressure turbine and installed at the outer side of the first rotating shaft; and a cavity formed between the inner side of the inner casing and the outer side of the first rotating shaft, characterized in that a slit for leading part of the compressed air to the cavity is formed between a wall surface of a rotor wheel of the compressor equipped with the last stage rotor of the compressor which is connected to the first rotating shaft and end of the inner casing, no bleed hole for leading part of the compressed air after flowing down the last stage of the compressor to the cavity is formed in the inner casing at a position on a downstream side of the last stage of the compressor, and

a stagger angle of the last stage stator of the compressor having no bleed hole in the inner casing is larger than a stagger angle of a last stage stator of the compressor having a bleed hole in an inner casing.

A method to determine the stagger angle of the last stage stator of the compressor for the 2-stage gas turbine comprising a compressor that compresses and discharges air, a combustor that combusts compressed air compressed by the compressor and fuel to generate combustion gas, a high pressure turbine connected to the compressor with a first rotating shaft and driven by the combustion gas generated by the combustor, a low pressure turbine driven by the combustion gas exhausted from the high pressure turbine and connected with a second rotating shaft, an inner casing located between the compressor and the high pressure turbine and installed at the outer side of the first rotating shaft, and supporting the last stage stator of the compressor at the inner side, a cavity formed between the inner side of the inner casing and the outer side of the first rotating shaft, and a slit for leading part of the compressed air to the cavity formed between a wall surface of a rotor wheel of the compressor equipped with the last stage rotor of the compressor which is connected to the first rotating shaft and end of the inner casing, comprising the steps of: (a) determining a stagger angle of the last stage stator when the inner casing has a bleed hole at the downstream side of the last stage stator to feed compressed air bleed to the cavity; and (b) determining a stagger angle of the last stage stator larger than the stagger angle determined in the step (a) when the inner casing has no bleed hole at the downstream side of the last stage stator.

According to the present invention, it is possible to achieve an inner bleed structure of the 2-shaft gas turbine in which the reliability of the last stage stator of the compressor is improved by restraining the reverse flow at a slit formed between the last stage rotor and stator of the compressor and a method to determine the stagger angle of the last stage stator of the compressor for the 2-shaft gas turbine.

### BRIEF DESCRIPTION OF THE DRAWINGS

FIG. 1 is a sectional view around the compressor outlet to the turbine inlet of the 2-shaft gas turbine in accordance with embodiment 1 of the present invention in the meridional plane direction.

FIG. 2 is a skeleton framework of the 2-shaft gas turbine in accordance with embodiments of the present invention.

FIG. 3 is a flow characteristics diagram of the slit, bleed hole, and inducer of the 2-shaft gas turbine in accordance with the embodiment 1 of the present invention.

FIG. 4 is a sectional view around the compressor outlet to the turbine inlet of the 2-shaft gas turbine in accordance with embodiment 2 of the present invention in a meridional plane direction.

FIG. 5 is a comparison diagram of the cross-section of the compressor last stage stator (22b) in the stator height direction and flow angle versus loss characteristics concerning the 2-shaft gas turbine in accordance with the embodiment 1 of the present invention.

FIG. 6 is a comparison diagram of the cross-section of the compressor last stage stator (22b) in the stator height direction and flow angle versus loss characteristics concerning the 2-shaft gas turbine in accordance with the embodiment 2 of the present invention.

FIG. 7 is a sectional view around the compressor last stage rotor and stator of the 2-shaft gas turbine in accordance with embodiment 3 of the present invention in the meridional plane direction.

FIG. 8 is a sectional view around the compressor last stage rotor and stator of a modification of the 2-shaft gas turbine in accordance with the embodiment 3 of the present invention in the meridional plane direction.

FIG. 9 is a sectional view around the last stage rotor and stator of the compressor of the 2-shaft gas turbine in accordance with embodiment 4 of the present invention in the meridional plane direction.

### DETAILED DESCRIPTION OF THE INVENTION

Inner bleed structures of 2-shaft gas turbines in accordance with embodiments of the present invention will be described with reference to the drawings.

### Embodiment 1

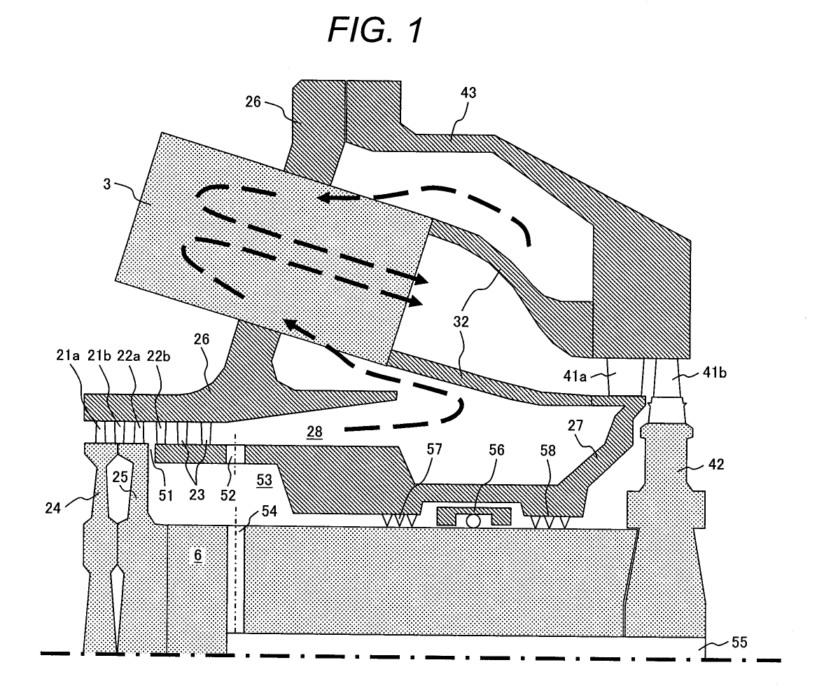

An inner bleed structure of the 2-shaft gas turbine in accordance with embodiment 1 of the present invention will be described by using FIG. 1 through FIG. 4.

Concerning the inner bleed structure of the 2-shaft gas turbine in accordance with the embodiment 1 of the present invention, a sectional view around the compressor outlet to the turbine inlet in the meridional plane direction is shown in FIG. 1.

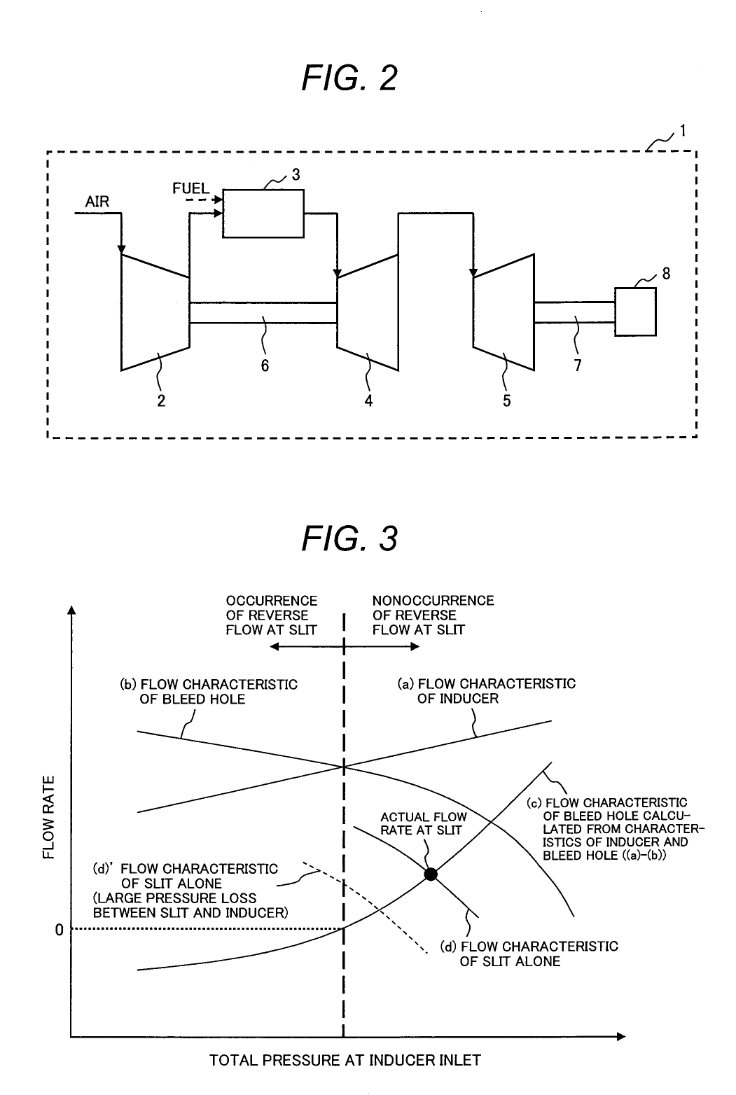

In a 2-shaft gas turbine having a inner bleed structure of the embodiment, as shown in FIG. 2, a skeleton framework of the 2-shaft gas turbine in accordance with embodiments of the present invention, air that will become working fluid flows into an axial flow compressor (2) to be compressed, then flows into a combustor (3), where air and fuel are mixed and jetted, and combusted to be high-temperature combustion gas.

The high temperature and high pressure combustion gas generated by the combustor (3) flows into a high-pressure gas turbine (4) that is connected to the compressor (2) by a rotating shaft (6) to drive the high pressure gas turbine (4), and drives the compressor (2) by the high-pressure gas turbine (4).

After flowing down through the high pressure gas turbine (4), the combustion gas flows into a low pressure gas turbine (5), and generates electric power when the gas passes through the low pressure gas turbine (5) by driving a generator (8) connected to the low pressure gas turbine (5) with a rotating shaft (7), a different shaft from the rotating shaft (6).

The combustion gas that passed through the low pressure gas turbine (5) is released into the atmosphere as exhaust gas. And the number of revolutions of the high pressure gas turbine and that of the low pressure gas turbine of the embodiment are presumed to be about 4500 rpm and about 3600 rpm respectively.

In the inner bleed structure of the 2-shaft gas turbine of the embodiment, as shown in FIG. 1, cooling air that cools turbine bucket (41b) located at the downstream side of turbine nozzle (41a) and constituting the high pressure gas turbine (4) is supplied as below. Part of the compressed air that passed through the diffuser (28) that is formed between the inner side of compressor casing (26) and outer side of inner casing (27) at the downstream side of the compressor last stage rotor (22a), last stage stator (22b), and exit guide vane (23) that constitute the compressor (2) is made to flow into inner bleed cavity (53) that is formed between the inner side of the inner casing (27) and the rotating shaft (6) located at the inner casing (27). The compressed air is fed from the inner bleed cavity (53) to the inside of the turbine bucket (41b) through a cooling path (not shown) formed in the turbine bucket wheel (42) equipped with the turbine bucket (41b) via inducer (54) and center hole (55) located in the rotating shaft (6).

In addition, besides the supply route described above, there is a route for the cooling air where part of the compressed air is led through slit (51) formed between the wall surface of rotor wheel (25) of the compressor and end of the inner casing (27) and located between the compressor last stage rotor (22a) and last stage stator (22b) to the compressor inner bleed cavity (53) formed at the inner side of the inner casing (27). Additionally, the positions in the shaft direction of the inducer (54) and the center hole (55) formed in the rotating shaft (6) are preferably located near the downstream side (turbine side) for shortening the machining distance of the center hole (55).

The compressed air that passed through the diffuser (28) flows into the combustor (3), and the compressed air is mixed with fuel and jetted, and combusted to generate high temperature gas in the combustor (3). The high temperature and high pressure combustion gas is fed to the turbine nozzle (41a) and turbine bucket (41b) that constitute the high pressure gas turbine (4) through the transition piece (32). Additionally, (26) and (43) are compressor casing and turbine casing respectively, compressor rotors (21a) and (22a) are located at the outer side of the compressor rotor wheels (24) and (25) respectively, and compressor stators (21b) and (22b) are installed to be located at the downstream side of the compressor rotors (21a) and (22a) respectively.

In the inner bleed structure of the 2-shaft gas turbine of the embodiment, since bearing (56) retaining the rotating shaft (6) is located at the inner side of the inner casing (27), seals (57) and (58) that face the outer surface of the rotating shaft (6) are located on the inner side of the inner casing (27) at the upstream side and downstream side of the bearing that are the downstream side of the inducer (54) located at the rotating shaft (6).

Next, the flow of main flow air will be described in the inner bleed structure of the 2-shaft gas turbine of the embodiment shown in FIGS. 1 and 2. The air flows into the compressor (2) first, passes through the plural rotors (21a) and stators (21b) inside the compressor, and finally passes the last stage made up of the rotor (22a) and stator (22b) and exit guide vanes (23) inside the compressor to become high pressure air, and the high pressure air flows into the diffuser (28) constituted of the compressor casing (26) and the inner casing (27).

Pressure, temperature, and flow rate of the high pressure air is respectively presumed to be about 1.6 MPa, 400° C., and 100 m/s at the time of flowing into the diffuser (28). The high pressure air flow slowed down to about 50 m/s by the diffuser (28) flows into the combustor (3).

And the high pressure air is mixed with fuel and combusted at the combustor (3) to generate high temperature and high pressure combustion gas, the temperature of which is raised to about 1300° C.

The high temperature and high pressure combustion gas generated by the combustion at the combustor (3) flows into the high pressure gas turbine (4) after passing through the transition piece (32) located at the downstream side of the combustor (3), and passes through the first stage turbine nozzle (41a) and turbine bucket (41b). At this time, the compressor (2) connected by the rotating shaft (6) is driven by driving the turbine bucket (41b).

On the other hand, there are two ways the routes of cooling air are fed to the turbine bucket (41b) and they are described below. A first route of the cooling air is a route in which the cooling air flows into the inner bleed cavity (53) through the bleed hole (52) formed in the inner casing (27) located on the inner side of the diffuser (28), and gets to the turbine bucket (41b) through the inducer (54) formed in the rotating shaft (6) and the center hole (55) of the shaft (6).

A second route of the cooling air is a route in which the cooling air flows into the inner bleed cavity (53) through the slit (51) formed between a wall surface of the rotor wheel (25) of the compressor equipped with the last stage rotor (22a) and end of the inner casing (27), and gets to the turbine bucket (41b) through the inducer (54) and the center hole (55) of the rotating shaft (6).

The size of the bleed hole (52) and the slit (51) are determined respectively, so that the flow rate of the compressed air led from the bleed hole (52) formed in the inner casing (27) to the inner bleed cavity (53) is larger than the flow rate of the compressed air led from the slit (51) to the inner bleed cavity (53).

The flow rate of the cooling air of the first route is presumed to be about 3% of the total suction air quantity of the compressor (2), the flow rate of the cooling air of the second route is presumed to be about 1% of the total suction air quantity of the compressor (2), and the temperature of the cooling air is presumed to be about 400° C., almost the same temperature as that of the main flow.

Additionally, for a route from the inner bleed cavity (53) to a vacancy between the turbine nozzle (41a) and the turbine bucket (41b), since the bearing (56) that supports the rotating shaft (6) is located at the inner side of the inner casing (27) that is on the way of the route, and seals (57) and (58) that restrain high pressure air flow into the bearing (56) are located on the inner side of the inner casing (27) at the upstream side and downstream side of the bearing (56), the flow rate of cooling air in this route is expected to be very small.

And the flow rate of the compressed air led from the slit (51) to the inner bleed cavity (53) is presumed to be 0.5% or more of the total suction air quantity of the compressor (2).

In this case, when there are two cooling air supply routes from the inner bleed cavity (53) to the turbine bucket (41b) of the bleed hole (52) in the inner casing (27) and the slit (51) formed between the end of the inner casing (27) and the rotor wheel (25) of the compressor as described above, the compressed air quantity that passes each route is determined by characteristics of the bleed hole (52), slit (51) and the inducer (54) formed in the rotating shaft (6). Specific determination process of these flow rates is shown below in FIG. 3.

FIG. 3 is a pattern diagram of flow characteristics of the slit (51), the bleed hole (52) of the inner casing (27), and the inducer (54) of the rotating shaft (6) against the inducer inlet pressure. In FIG. 3, a flow rate that passes through the slit (51) can be obtained as an intersection of a characteristic calculated from flow characteristics of the bleed hole (52) and inducer (54) ((c) in FIG. 3), and a flow characteristic of the inducer alone ((d) in FIG. 3).

In the pattern diagram of flow characteristics of FIG. 3, when obstacles exist between the slit 51 and the inducer 54, the characteristic moves to the low flow rate side shown by a dotted line in the diagram because of increased pressure loss, and a reverse flow becomes prone to occur.

In addition, since the last stage wheel (25) of the compressor that constitutes the slit (51) becomes a rotating wall, when the flow rate through the slit (51) is very small, even if the flow rate is a positive value, there is a possibility that the flow cannot overcome the centrifugal force of the rotating wall and reverse flow occurs at the slit (51) locally.

In the inner bleed structure of the 2-shaft gas turbine of the embodiment, since seals do not exist in an air path route, in which the high pressure air flows, from the slit (51) formed between the end of the inner casing (27) and the wall surface of the rotor wheel (25) of the compressor and located between the last stage rotor (22a) and stator (22b) of the compressor to the inducer (54) formed in the rotating shaft (6), pressure loss of the high pressure air between the slit (51) and the inducer (54) is small.

For this reason, since the high pressure air flow rate that passes through the slit (51) increases, the occurrence of the reverse flow at the last stage rotor (22a) side of the compressor of the slit (51) can be restrained. It is proved that the high pressure air flow rate that passes through the slit (51) is preferably 0.5% or more of the total suction air quantity of the compressor on the basis of flow analysis result of the inner bleed parts including the slit (51), the bleed hole (52) formed in the inner casing (27), and the inner bleed cavity formed in the inner side of the inner casing (27).

In summary, in the inner bleed structure of the 2-shaft gas turbine of the embodiment, since the high pressure air that passes through the slit (51) formed between the end of the inner casing (27) and the wall surface of the rotor wheel (25) of the compressor is increased, the reverse flow that is generated at the last stage rotor (22a) side of the compressor of the slit (51) is restrained to reduce loss caused by flow turbulence at the last stage stator (22b) of the compressor located at the downstream side of the slit (51) and stress acting on the last stage stator (22b) of the compressor because of the occurrence of instability phenomena caused by flow separation etc., whereby reliability of the last stage stator (22b) of the compressor can be improved. Moreover, the inner bleed structure of the 2-shaft gas turbine is simplified and cost reduction effects can also be expected.

According to the embodiment, the inner bleed structure of the 2-shaft gas turbine can be achieved in which reliability of the last stage stator of the compressor is improved by restraining the reverse flow at the slit formed between the last stage rotor and stator of the compressor.

### Embodiment 2

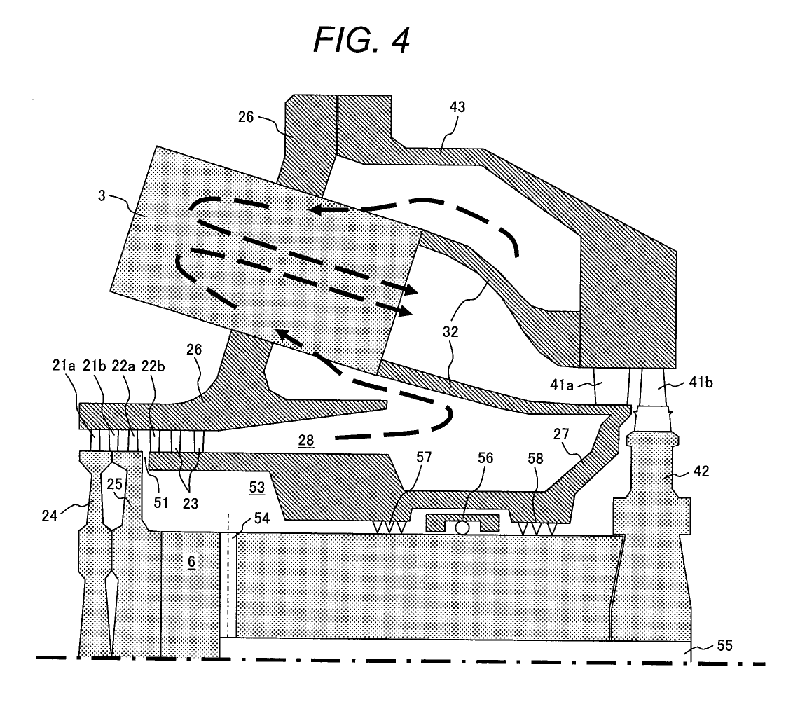

Next, an inner bleed structure of the 2-shaft gas turbine and a method to determine the stagger angle of the last stage stator of the compressor for the 2-stage gas turbine in accordance with embodiment 2 of the present invention will be described by using FIG. 4 through FIG. 6.

Since the inner bleed structure of the 2-shaft gas turbine of the embodiment has almost the same basic constitution as the embodiment 1 shown in FIG. 1, description of the common constitution of both embodiments is omitted, and only the differences will be described below.

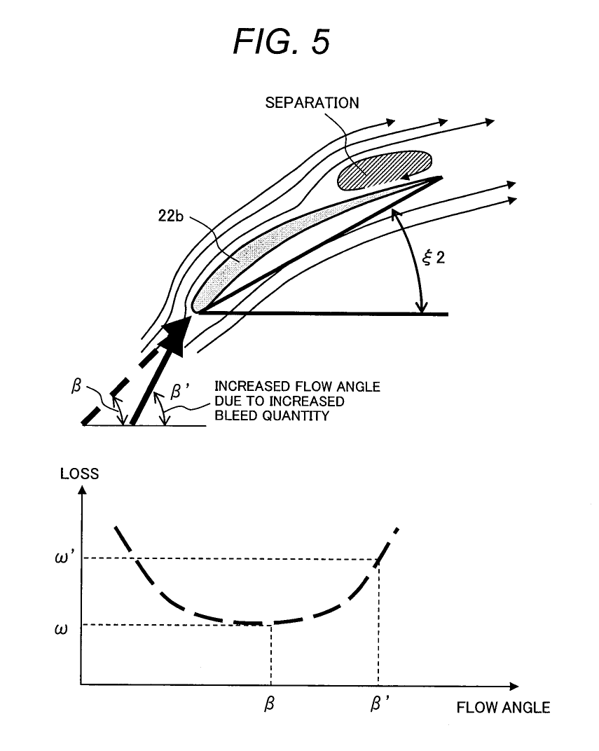

A sectional view around the compressor outlet to the turbine inlet of the embodiment in the meridional plane direction is shown in FIG. 4, and a comparison of the cross-section of the last stage stator (22b) of the compressor in the stator height direction and flow angle versus loss characteristics are shown in FIG. 5. Differences from the inner bleed structure of the 2-shaft gas turbine of the embodiment 1 are that inner casing (27) does not have a bleed hole (52), and stagger angle (ξ 3) of the last stage stator (22b) of the compressor is larger than the stagger angle (ξ 2) of the last stage stator (22b) of the compressor of the embodiment 1.

First, in the inner bleed structure of the 2-shaft gas turbine of the embodiment shown in FIG. 4, since the bleed hole (52) is not formed in the inner casing (27), there is only one cooling air supply route in which part of the compressed air that flows down through the last stage rotor (22a) of the compressor and flows into the last stage stator (22b) of the compressor is led through slit (51) formed between the rotor wheel (25) of the compressor and end of the inner casing (27) and located between the last stage rotor (22a) and the last stage stator (22b) of the compressor to the inner bleed cavity (53), from which the cooling air is fed to turbine bucket (41b) finally through inducer (54) and center hole (55) that are formed in the rotating shaft (6).

Thus, in the inner bleed structure of the 2-shaft gas turbine of the embodiment, since the flow rate that passes the slit (51) is larger than that of the inner bleed structure of the 2-shaft gas turbine of the embodiment 1, possibility of reverse flow occurrence can be further reduced.

But simply omitting the bleed hole (52) causes problems with the last stage stator (22b) of the compressor. As described above, since whole cooling air that cools the turbine bucket (41b) is led through the slit (51), the flow rate of the inner side of the last stage stator (22b) of the compressor is reduced locally. Since axial flow velocity is also reduced due to the reduction of the flow rate, flow angle of the inner side of the last stage stator (22b) of the compressor is increased from β to β′, as shown in the upper part of FIG. 5.

Due to the increase of flow angle of the last stage stator (22b) of the compressor from β to β′, blade loss of the last stage stator (22b) of the compressor increases from ω to ω′, as shown in the lower part of FIG. 5, and separation of the flow may occur to cause instability phenomena that affect the reliability of blades.

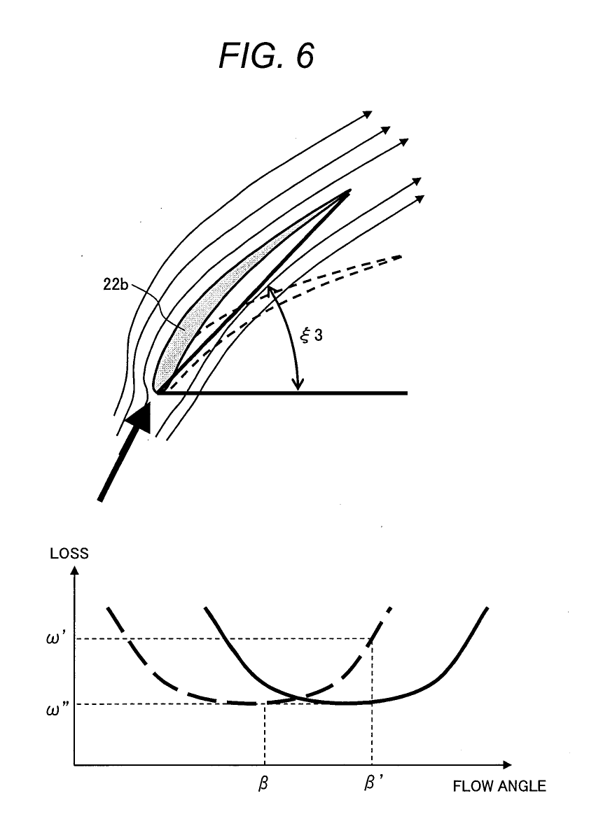

For that reason, in the inner bleed structure of the 2-shaft gas turbine and the method to determine the stagger angle of the last stage stator of the compressor for the 2-stage gas turbine of the embodiment, along with eliminating the bleed hole (52) in the inner casing (27), as shown in upper part of FIG. 6, the stagger angle ξ 3 of last stage stator (22b) of the compressor is increased compared with the stagger angle ξ 2 of last stage stator (22b) of the compressor for the 2-stage gas turbine of the embodiment 1 in installation.

That is, in the method to determine the stagger angle of the last stage stator of the compressor for the 2-stage gas turbine of the embodiment, the stagger angle of the last stage stator is determined by first process where the stagger angle of the last stage stator is determined in the case of the inner casing having the bleed hole, which is located at downstream side of the last stage stator, from which the compressed air is fed to the cavity, and second process where the stagger angle of the last stage stator is determined to be larger than the stagger angle determined in the first process in the case of the inner casing not having the bleed hole, which is located at the downstream side of the last stage stator.

In this case, the stagger angle ξ of the last stage stator of the compressor is the angle between the straight line connecting the leading edge and the trailing edge of the installed stator (22b) and the axis line of the compressor. The last stage stator (22b) of the compressor for the 2-stage gas turbine of the embodiment is installed with the stagger angle (ξ 3) increased, for example, by about 3° compared with the stagger angle of the last stage stator of the compressor for the 2-stage gas turbine of the embodiment 1 (ξ 2).

By increasing the stagger angle, since flow angle characteristics of the last stage stator (22b) in the inner bleed structure of the 2-shaft gas turbine of the embodiment can be shifted to a larger flow angle side (from broken line to solid line), blade loss of the last stage stator (22b) of the compressor is shifted from ω′ shown by the broken line to ω″ shown by the solid line even though there is an increase of flow angle from β to β′, and accordingly increase of blade loss and separation of flow are considerably restrained.

In summary, in the inner bleed structure of the 2-shaft gas turbine and a method to determine the stagger angle of the last stage stator of the compressor for the 2-stage gas turbine in accordance with the embodiment, the possibility of reverse flow occurrence in the slit (51) can be further restrained. In addition, processing to form the bleed hole (52) in the inner casing (27) is made redundant to contribute to the reduction of cost and man-hours.

According to the embodiment, an inner bleed structure of the 2-shaft gas turbine and a method to determine the stagger angle of the last stage stator of the compressor for the 2-stage gas turbine can be achieved in which reliability of the last stage stator of the compressor is improved by restraining reverse flow at a slit formed between the last stage rotor and stator of the compressor.

### Embodiment 3

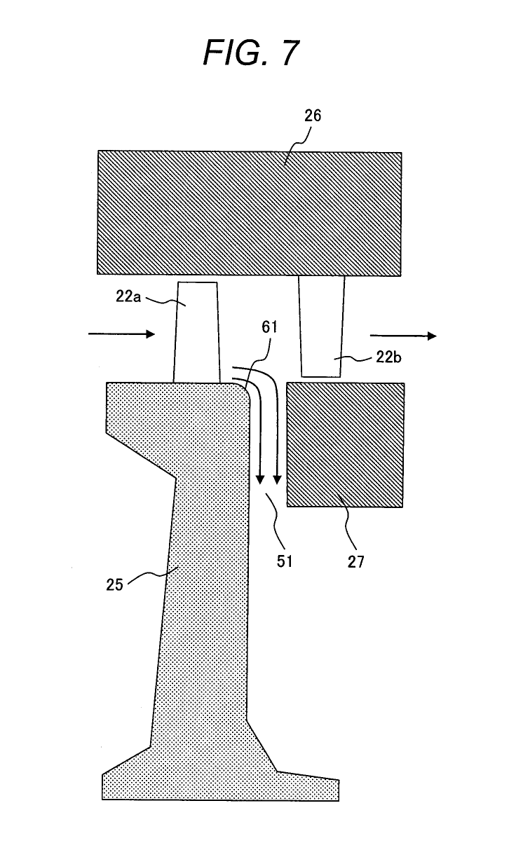

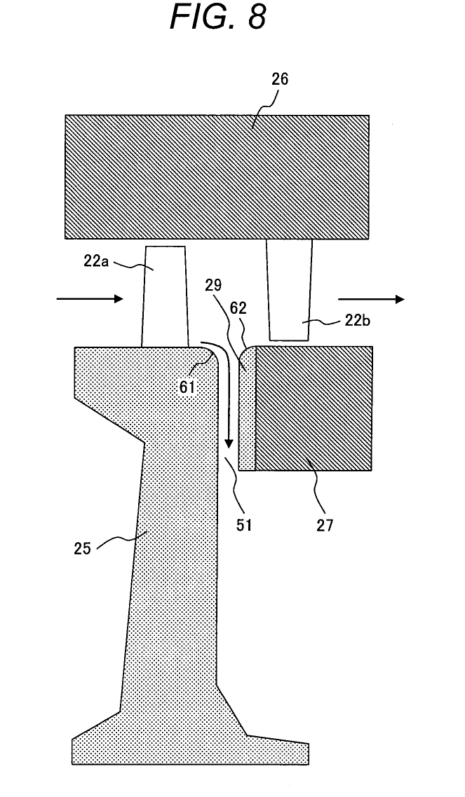

Next, an inner bleed structure of the 2-shaft gas turbine in accordance with embodiment 3 of the present invention will be described by using FIG. 7 and FIG. 8.

Since the inner bleed structure of the 2-shaft gas turbine of the embodiment has almost the same basic constitution as the embodiment 1 shown in FIG. 1, description of the common constitution of both embodiments is omitted, and only the differences will be described below.

A sectional view around the last stage rotor (22a) and stator (22b) of the compressor of the embodiment in the meridional plane direction is shown in FIG. 7. In the wall surface of the last stage wheel (25) of the compressor in the inner bleed structure of the 2-shaft gas turbine of the embodiment shown in FIG. 7, curved chamfer (61) is made on a corner part that is a connection part of the wall surface of the last stage wheel (25) of the compressor that forms slit (51) between the end of inner casing (27) and wall surface that constitutes the path of main flow in which the last stage rotor (22a) of the compressor that make compressed air flow down exists. And routes of main flow and turbine blade cooling air are shown by arrows respectively.

In general, when a flow flows into an opening such as the slit (51), pressure loss in the case of inlet port being chamfered is 10% or less of that in the case of inlet port not being chamfered. For that reason, it is expected that separation of flow is also restricted and circulating zone in the last stage rotor (22a) side of the compressor in proximity to the slit (51) hardly exists, whereby the possibility of occurrence of reverse flow is reduced.

Moreover, since pressure loss is reduced at the slit (51) by making chamfer 61 on the connection part of the wall surface that forms the slit (51) and wall surface that constitutes the path of main flow, pressure loss of the cooling air that flows from the slit (51) into the inducer (54) of rotating shaft (6) is also reduced.

As a result, also in flow distribution shown in FIG. 3, since flow characteristics shift to the large flow rate side and flow rate passing through the slit (51) increases, the possibility of reverse flow is expected to be further reduced. In addition, since loss of the cooling air during passing through the slit (51) is reduced, the cooling air temperature at the inducer (54) of the rotating shaft (6) is reduced, which is advantageous for turbine blade cooling.

Next, a modification of the inner bleed structure of the 2-shaft gas turbine of the embodiment is shown in FIG. 8. In the modification of the inner bleed structure of the 2-shaft gas turbine, extension member (29) to narrow the width of the slit (51) is installed on the wall surface of the end of the inner casing (27) that faces the wall surface of the final stage rotor wheel (25) of the compressor that forms the slit (51).

In the wall surface of the extension member (29) installed to the wall surface of end of the inner casing (27), curved chamfer (62) is made on a corner part that is a connection part of the wall surface of the extension member (29) and wall surface that constitutes the path of main flow in which the last stage stator (22b) of the compressor that make compressed air flow down exists. Additionally, the shape of the extension member (29) is presumed to be ring-shaped.

When the inner bleed structure of the 2-shaft gas turbine of the embodiment is modified to the modification shown in FIG. 8, since width of the slit (51) is reduced compared to the embodiment shown in FIG. 7, flow rate of the cooling air that passes through the slit (51) is reduced. However, since the chamfer (62) is made on the wall surface of the extension member (29), the possibility of reverse flow is further decreased and flow angle change at the inner side of the last stage stator (22b) of the compressor decreases due to the decrease of passing flow rate. Thus increase of loss at the last stage stator (22b) of the compressor and occurrence of separation are further restricted.

In summary, the inner bleed structure of the 2-shaft gas turbine of the embodiment can further decrease the possibility of reverse flow occurrence compared to the embodiments 1 and 2, which is advantageous in efficiency and reliability.

Moreover, the cooling air temperature at the inducer (54) inlet port of the rotating shaft (6) is decreased due to the loss reduction at the slit (51), which is also advantageous for turbine blade cooling. Additionally, the flow angle increase of the last stage stator (22b) of the compressor due to the passing flow rate of the slit (51) can be dealt with by installing a ring-shaped extension member (29) to the inner casing (27).

According to the embodiment, an inner bleed structure of the 2-shaft gas turbine can be achieved in which reliability of the last stage stator of the compressor is improved by restraining the reverse flow at a slit formed between the last stage rotor and stator of the compressor.

### Embodiment 4

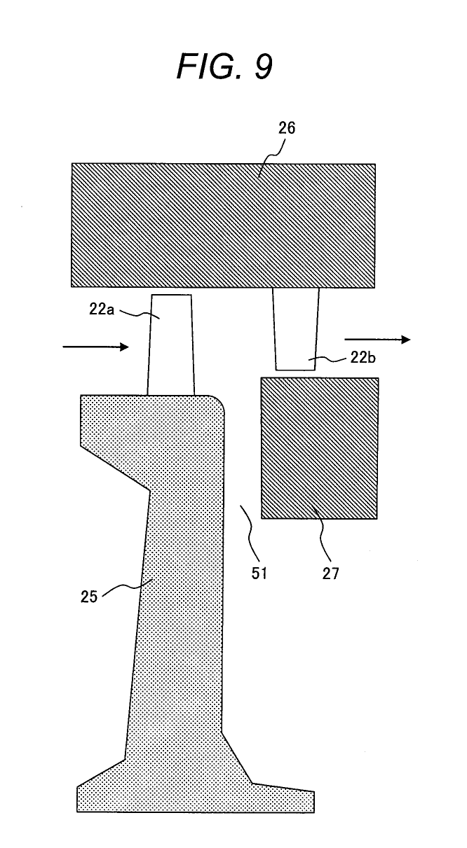

Next, an inner bleed structure of the 2-shaft gas turbine in accordance with embodiment 4 of the present invention will be described by using FIG. 9.

Since the inner bleed structure of the 2-shaft gas turbine of the embodiment has almost the same basic constitution as the embodiment 1 shown in FIG. 1, description of the common constitution of both embodiments is omitted, and only the differences will be described below.

FIG. 9 is a sectional view around the last stage rotor and stator of the compressor of the inner structure of the 2-shaft gas turbine of the embodiment in the meridional plane direction. The embodiment is different from other embodiments in that a position of the outer wall surface in the radial direction of rotor wheel (25) of the compressor that constitutes the inner path of the last stage rotor (22a) of the compressor is lowered to have smaller dimension in the radial direction than a position of the outer wall surface in the radial direction of the inner casing (27) that constitutes the inner path of the last stage stator (22b) of the compressor.

In the inner bleed structure of the 2-shaft gas turbine of the embodiment, since the position of the outer wall surface in the radial direction of rotor wheel (25) of the compressor that constitutes the inner path of the last stage rotor (22a) of the compressor is constituted to be lower than the position of the outer wall surface in the radial direction of the inner casing (27) that constitutes the inner path of the last stage stator (22b) of the compressor, axial flow velocity flowing into the last stage stator (22b) of the compressor becomes larger than axial flow velocity after passing through the last stage rotor (22a) of the compressor.

That is, flow angle into the last stage stator (22b) of the compressor tends to be smaller compared with the case in which inner side path height of the last stage stator (22b) of the compressor and that of the last stage rotor (22a) of the compressor are the same. As described above, though there are problems of increase of loss and occurrence of separation because the flow angle into the last stage stator (22b) of the compressor tends to increase due to bleeding of cooling air from the slit (51), these problems can be lightened by adopting the inner bleed structure of the 2-shaft gas turbine of the embodiment.

Additionally, in the wall surfaces of the last stage wheel (25) of the compressor shown in FIG. 9, chamfer is not made on a corner part that is a connection part of the wall surface that forms the slit (51) and wall surface that constitutes the path of main flow in which the last stage rotor (22a) of the compressor exists, but the chamfer (61) with curve can be made on the corner part of the wall surface of the last stage wheel (25) of the compressor as the inner bleed structure of the 2-shaft gas turbine of embodiment 3 shown in FIG. 7.

When the chamfer (61) is made on the corner part of the wall surface of the last stage wheel (25) of the compressor, since the flow rate of the cooling air passing through the slit (51) tends to increase, the inner side flow angle increase of the last stage stator (22a) of the compressor can be restrained by using the structure of the embodiment.

According to the embodiment, an inner bleed structure of the 2-shaft gas turbine can be achieved in which reliability of the last stage stator of the compressor is improved by restraining reverse flow at a slit formed between the last stage rotor and stator of the compressor.

The present invention is applicable to inner bleed structures of the 2-shaft gas turbine that feeds cooling air from the compressor to the turbine.

What is claimed is:

1. An inner bleed structure of a 2-shaft gas turbine comprising:
a compressor that compresses and discharges air;
a combustor that combusts compressed air compressed by the compressor and fuel to generate combustion gas;
a high pressure turbine connected to the compressor with a first rotating shaft and driven by the combustion gas generated by the combustor;
a low pressure turbine driven by the combustion gas exhausted from the high pressure turbine and connected with a second rotating shaft;
an inner casing located between the compressor and the high pressure turbine and installed at the outer side of the first rotating shaft; and
a cavity formed between the inner side of the inner casing and the outer side of the first rotating shaft, characterized in that
a slit for leading part of the compressed air to the cavity is formed between a wall surface of a rotor wheel of the compressor equipped with the last stage stator of the compressor which is connected to the first rotating shaft and end of the inner casing, and
a bleed hole for leading part of the compressed air after flowing down the last stage of the compressor to the cavity is formed in the inner casing at a position on a downstream side of the last stage of the compressor.

2. The inner bleed structure of the 2-shaft gas turbine according to claim 1,
wherein each the size of the bleed hole and the slit is determined so that the flow rate of the compressed air led from the bleed hole formed in the inner casing to the cavity is larger than the flow rate of the compressed air led from the slit to the cavity.

3. The inner bleed structure of the 2-shaft gas turbine according to claim 1,
wherein the flow rate of the compressed air led from the slit to the cavity is determined to be 0.5% or more of the total suction air quantity of the compressor.

4. An inner bleed structure of a 2-shaft gas turbine comprising:
a compressor that compresses and discharges air;
a combustor that combusts compressed air compressed by the compressor and fuel to generate combustion gas;
a high pressure turbine connected to the compressor with a first rotating shaft and driven by the combustion gas generated by the combustor;
a low pressure turbine driven by the combustion gas exhausted from the high pressure turbine and connected with a second rotating shaft;
an inner casing located between the compressor and the high pressure turbine and installed at the outer side of the first rotating shaft; and
a cavity formed between the inner side of the inner casing and the outer side of the first rotating shaft, characterized in that
a slit for leading part of the compressed air to the cavity is formed between a wall surface of a rotor wheel of the compressor equipped with the last stage rotor of the compressor which is connected to the first rotating shaft and end of the inner casing,
no bleed hole for leading part of the compressed air after flowing down the last stage of the compressor to the cavity is formed in the inner casing at a position on a downstream side of the last stage of the compressor, and
a stagger angle of the last stage stator of the compressor having no bleed hole in the inner casing is larger than a stagger angle of a last stage stator of the compressor having a bleed hole in an inner casing.

5. The inner bleed structure of the 2-shaft gas turbine according to claim 1,
wherein a position of the outer wall surface in the radial direction of the rotor wheel of the compressor, which is constituting inner path of the last stage rotor of the compressor is lowered to have smaller dimension in the radial direction than a position of the outer wall surface in the radial direction of the inner casing, which is constituting inner path of the last stage stator of the compressor.

6. The inner bleed structure of the 2-shaft gas turbine according to claim 1,
wherein the wall surface of the rotor wheel of the compressor to form the slit equipped with the last stage rotor of the compressor is provided with a chamfer with curve on a corner part thereof that is a connection part of the wall surface of the rotor wheel which constitutes the path of main flow in which the last stage rotor of the compressor exists.

7. The inner bleed structure of the 2-shaft gas turbine according to claim 1,
wherein a member to narrow the width of the slit is installed on the wall surface of the end of the inner casing constituting the last stage stator side of the compressor located near the slit.

8. The inner bleed structure of the 2-shaft gas turbine according to claim 7,
wherein the wall surface of the member to narrow the width of the slit is provided with a chamfer with curve on a corner part thereof that is a connection part of the wall surface of the rotor wheel which constitutes the path of main flow in which the last stage rotor of the compressor exists.

9. A method to determine the stagger angle of the last stage stator of a compressor for a 2-stage gas turbine comprising a compressor that compresses and discharges air, a combustor that combusts compressed air compressed by the compressor and fuel to generate combustion gas, a high pressure turbine connected to the compressor with a first rotating shaft and driven by the combustion gas generated by the combustor, a low pressure turbine driven by the combustion gas exhausted from the high pressure turbine and connected with a second rotating shaft, an inner casing located between the compressor and the high pressure turbine and installed at the outer side of the first rotating shaft, and supporting the last stage stator of the compressor at the inner side, a cavity formed between the inner side of the inner casing and the outer side of the first rotating shaft, and
a slit for leading part of the compressed air to the cavity formed between a wall surface of a rotor wheel of the compressor equipped with the last stage rotor of the compressor which is connected to the first rotating shaft and end of the inner casing, comprising the steps of:
(a) determining a stagger angle of the last stage stator when the inner casing has a bleed hole at the downstream side of the last stage stator to feed compressed air bleed to the cavity; and
(b) determining a stagger angle of the last stage stator larger than the stagger angle determined in the step (a) when the inner casing has no bleed hole at the downstream side of the last stage stator.
